(19) United States
(12) Patent Application Publication
(10) Pub. No.: US 2023/0169272 A1
(43) Pub. Date: Jun. 1, 2023

(54) COMMUNICATION FRAMEWORK FOR AUTOMATED CONTENT GENERATION AND ADAPTIVE DELIVERY

(71) Applicant: INTERNATIONAL BUSINESS MACHINES CORPORATION, Armonk, NY (US)

(72) Inventors: Andrew BRANTLEY, Irving, TX (US); Susan CHRISTIAN, Grapevine, TX (US); Kenechukwu Chidozie NWANKWO, Rowlett, TX (US); Jeffrey EDGINGTON, Fort Worth, TX (US)

(21) Appl. No.: 17/538,271

(22) Filed: Nov. 30, 2021

(51) Int. Cl. G06F 40/30; G06F 40/40; G10L 15/26; G06V 40/20; G06V 40/16

(52) U.S. Cl. CPC G06F 40/30; G06F 40/40; G10L 15/26; G06V 40/20; G06V 40/176

(57) ABSTRACT

Methods, computer program products, and systems are presented. The methods include, for instance: input data stream capturing a live discussion on topics for strategic messages are processed and analyzed to formulate a strategic message model by machine learning based on a topic profile. A strategic message instance for a presentation is generated by use of the strategic message model. The presentation is monitored real time and any delivery issues are dealt with real time according to a delivery profile. The presentation is evaluated for topic coverage and audience reactions and a satisfactory delivery is used to retrain the strategic message model.

### TECHNICAL FIELD

The present disclosure relates to content generation and delivery framework, and more particularly to methods, computer program products, and systems for automated content modeling, customized content generation, and real time feedback by delivery monitoring.

### BACKGROUND

Conventional content delivery frameworks employing content extraction by cognitive language analytics are limited to static subjects with extensive dataset as in online education programs or training programs on academic/technical courses. Because any such subject matter is often beyond current capacities of natural language processing and natural language classification, human subject matter experts are often required to manually annotate and review any extracted content, to identify alternative expressions of the same content based on various levels of audiences and preferences, and otherwise to create the content for delivery. On the receiving end, the audience receives previously produced content that are mostly unaffected by any audience reaction, even if the audiences are engaged with content via tests, polls, and/or course evaluations to prove progress with the program or to provide feedback information to the human subject matter experts for the future.

### SUMMARY

The shortcomings of the prior art are overcome, and additional advantages are provided, through the provision, in one aspect, of a method. The method includes, for instance: obtaining, by one or more processor, input data stream capturing a live discussion by one or more strategists on topics of strategic messages to deliver to an audience, the input data stream including multimedia data generated by meeting data input/output devices located at the live discussion; formulating, by the one or more processor, a strategic message model by machine learning including the topics and corresponding attributes according to a topic profile based on the input data stream as training data; generating, by the one or more processor, a strategic message instance by use of the strategic message model to deliver; monitoring, by the one or more processor, a presentation of the strategic message instance by a presenter by detecting delivery issues and responding to the presenter with respective resolutions for the delivery issues, according to a delivery profile; and updating, by the one or more processor, the strategic message model based on a delivery content capturing the presentation and a reaction by the audience corresponding to the presentation, based on ascertaining that the presentation has been evaluated as sufficiently covering the topics and well received by the audience.

Additional features are realized through the techniques set forth herein. Other embodiments and aspects, including but not limited to computer program products and systems, are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts a strategic content ecosystem focusing on components for automatically formulating strategic messages, in accordance with one or more embodiments set forth herein;

FIG. 2 depicts the strategic content ecosystem on components for optimally delivering the strategic messages, in accordance with one or more embodiments set forth herein;

FIG. 3 depicts a workflow for the strategic content ecosystem, in accordance with one or more embodiments set forth herein;

FIG. 4 depicts a workflow for the strategy management system performing block 310 of FIG. 3, in accordance with one or more embodiments set forth herein;

FIG. 5 depicts a workflow for the delivery agent system as performed in block 330 of FIG. 3, in accordance with one or more embodiments set forth herein;

FIG. 6 depicts a cloud computing node according to an embodiment of the present invention;

FIG. 7 depicts a cloud computing environment according to an embodiment of the present invention; and

FIG. 8 depicts abstraction model layers according to an embodiment of the present invention.

### DETAILED DESCRIPTION

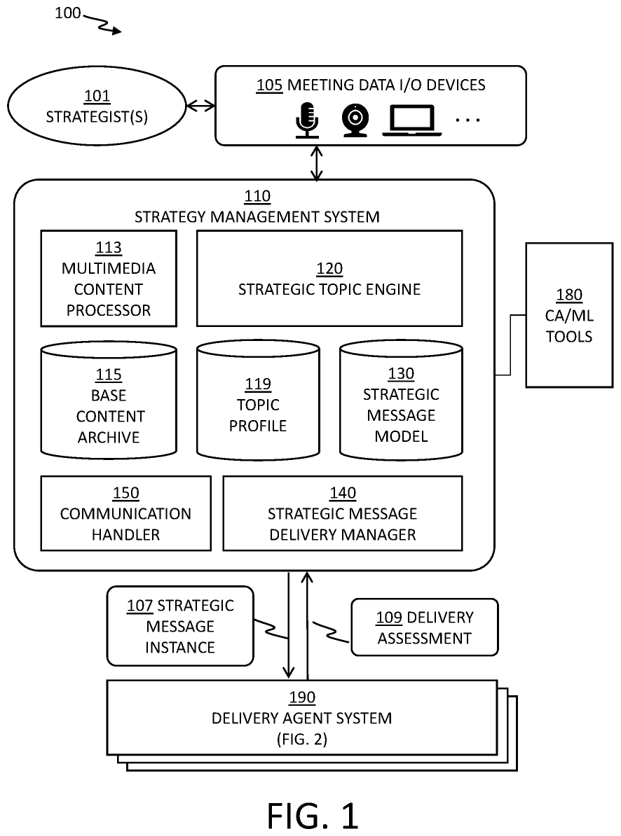

FIG. 1 depicts a strategic content ecosystem 100 focusing on components for automatically formulating strategic messages, in accordance with one or more embodiments set forth herein.

The strategic content ecosystem 100 includes a strategy management system 110 and a delivery agent system 190. The strategy management system 110 automatically generates a strategic message instance 107 based on conversation amongst the two or more strategists 101, as captured by meeting data input/output devices 105. The strategy management system 110 produces a strategic message instance 107 and sends to the delivery agent system 190.

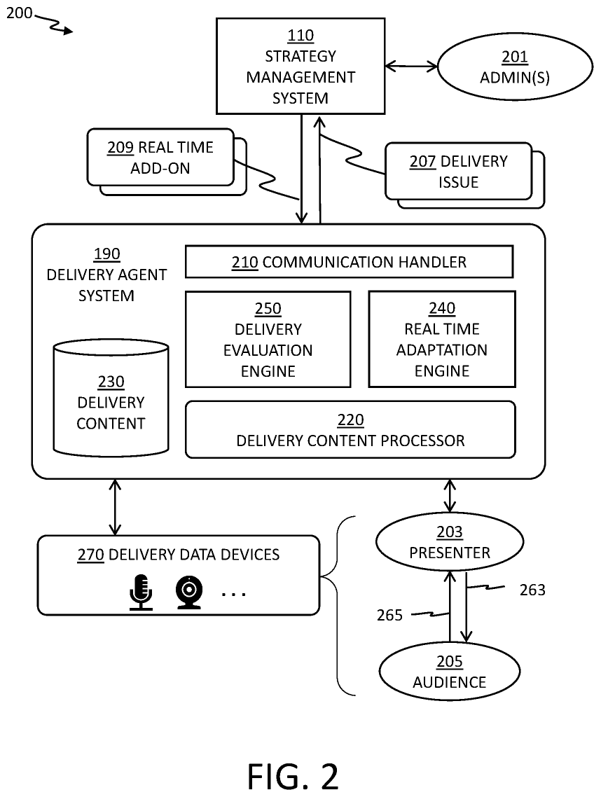

The delivery agent system 190 is operatively coupled to the strategy management system 110 via a digital communication network. The delivery agent system 190 facilitates a delivery of the strategic message instance 107 and returns a delivery assessment 109 back to the strategy management system 110. Details of the delivery agent system 190 are presented in FIG. 2 and corresponding description.

The meeting data input/output devices 105 include, but are not limited to, one or more video cameras to capture a synchronized audio/video input stream data, one or more microphones to capture audio data that are either embedded with the one or more video cameras or separated from the video cameras for audio reception throughout a conference room, and any computing machinery to input text data directly to the strategy management system 110 such as a keyboard to directly type in the text data, an optical character recognition (OCR) device for handwritten notes on paper or a whiteboard in the conference room via video analysis, etc.

The strategy management system 110 is operatively coupled to cognitive analytics/machine learning (CA/ML) tools 180 of video analytics, audio analytics, and text analytics. Video analytics includes functionalities of recognizing faces for speaker identification, gestures or behavioral patterns, facial expressions for sentiment analysis. Audio analytics includes functionalities of natural language processing (NLP) including speech-to-text, human speaking voice analytics for speaker identification, tone, pitch, and volume with respect to sentiment and semantics analysis. Text analytics includes unstructured text clustering for semantics, natural language classification (NLC), natural language understanding (NLU), language identification and translation, sentiment analysis based on word choices, etc. Usage of the CA/ML tools 180 in the strategic content ecosystem 100 are customized to achieve fully automated formulation of strategic content as well as dynamic delivery monitoring and real time response for any delivery issues.

The strategy management system 110 includes a multimedia content processor 113, a base content archive 115, a topic profile 119, a strategic topic engine 120, and a strategic message model 130, for automatically generating strategic content based on inputs from the meeting data input/output devices 105. The strategy management system 110 further includes a strategic message delivery manager 140 and a communication handler 150, for facilitating, monitoring, and responding to a particular delivery of strategic content via the delivery agent system 190.

As noted above, conventional content delivery frameworks rely on human subject matter experts for content generation, even if some level of content extraction by cognitive language analytics are applied. Also, the conventional content delivery frameworks are limited to static subject matters with extensive dataset as in online education/training programs on academic courses. Because any such subject matter is often beyond current capacities of NLP/NLC, human subject matter experts are often required to manually annotate and review any extracted content, to identify alternative expressions of the same content based on various levels of audiences and preferences, and otherwise to create the content for delivery. On the receiving end, the audience receives previously produced content that are mostly unaffected by any audience reaction, even if the audiences are engaged with content via tests, polls, and/or course evaluations to prove participation and/or progress with the program or to provide feedback information to the human subject matter experts for the future. Conventional content delivery frameworks often structured to evaluate comprehension of the subject matter by the audience rather than assessing how effectively the subject matter was presented. Similarly, conventional conference applications often provide content generation by recording of meetings as a video clip and offers for a playback for later deliveries. Such conference recordings would be used for repetition of the same content to many audiences who had not been present at the meetings but cannot contribute to any development of related subject matters as no content is processed or analyzed to extract computable units of the subject matter. Also a delivery of such conference recordings is an exact reproduction of the conference, lacking adaptation to changing circumstances caused by a time lapse between the conference and the delivery, and different audiences.

The strategy management system 110 of the strategic content ecosystem 100 automatically generates the strategic message model 130 based on the input stream data captured by the meeting data input/output devices 105 as guided by the topic profile 119, by use of the multimedia content processor 113 and the strategic topic engine 120. The topic profile 119 can be interactively generated prior to or in the beginning of the meeting, in which one of the strategists 101 can type in any topic directive and the meeting data input/output devices 105 would feedback with the display of the input text, the number of people in the meeting. The topic profile 119 can interactively verify what the strategy management system 110 derives as topics in real time during the meeting by prompting the strategists 101 with a topic with description such as “NEW Topic ABC (Yes/No)?” or “Topic ABC related with Topic LMN (Yes/No)?”.

The multimedia content processor 113 of the strategy management system 110 processes the inputs captured by the meeting data input/output devices 105 into manageable data units according to media types of the inputs and labels the data units with corresponding metadata. The multimedia content processor 113 processes video media data by extracting audio stream and by video frame parsing. The multimedia content processor 113 processes audio media data by identifying language, by identifying speaker, and by transcribing. The multimedia content processor 113 processes text media data by synchronizing the text media data with other media data from the meeting. The multimedia content processor 113 stores processed inputs in the base content archive 115.

In this specification, the term “base content” indicates normalized data units that are identifiable and associated with envelope information. Exemplary data units may be a sentence, a word, a gesture, an interjection, a facial expression, or a certain time unit with fixed lengths such as a single frame in a video data. The base content archive 115 may store all incoming content processed into certain formats and sizes that are ready for analysis by use of cognitive analytics tools per media types. The base content archive 115 may store a discussion by the strategists 101 as captured by the meeting data input/output devices 105 or delivery content reported from the delivery agent system 190 in cases when the delivery assessment 109 is above a predefined threshold. Envelope information, corresponding to respective data units of base content, describes and identifies respective data units stored in the base content archive 115 in aspects including timestamps or any type of indices that identifies the data unit for retrieval and playback, metadata of the data unit such as media type, an originator of the data unit, and any other preliminary analytics applied to the data unit by the media content processor 113. The base content archive 115 includes, or is operatively coupled to, playback/display mechanisms for data units of respective media types, including but not limited to, video, audio, and text, separately or as a combined whole.

The strategic topic engine 120 extracts topics from respective media data units stored in the base content archive 115, scores respective topics based on the rules and configuration parameters set in the topic profile 119, classifies the topics for a hierarchy/relationship amongst the topics and defines topology of the topics accordingly in the strategic message model 130. The strategic topic engine 120 can assess significance of a topic by a frequency of the topic mentioned during the meeting, how many media type data would specify the topic, which contextually enhancing the significance of the topic as in speaking the topic and at the same time others giving a high five to the speaker or nodding as simultaneity of gestures and utterances can be checked by the timestamps in the base content. Similarly, if a topic was spoken and at the same time other participants were shaking heads or frowning, then the topic would be marked for lesser approval than the nodding or high fives. The strategic topic engine 120 populates the strategic message model 130 with attributes of the topics, including, but not limited to, various expressions for the topic in varying audience types, annotations on the topic by a particular person or other tools of delivery specific to the topic such as anecdotes, quotes, short stories, statistics, aphorisms, etc., to maximize delivery of the topic according to a score of the topic indicating relative significance of the topic among all topics in the strategic message model 130, as being weighted by who authored, verified or otherwise approved the topic amongst the strategists 101. For example, if a head of an organization wants a topic ABC to be a new motto for the organization and most of the strategists 101 verbally approves or otherwise positively comments on the topic ABC, then the topic ABC would be weighted fully, for example, 1.0 out of a weight scale of [0.0, . . . , 1.0] in 0.1 increments, for a score 0.35 based on a significance relative to other topics in the strategic message model 130, resulting in a weighted score of 0.35, which indicates that the topic ABC would carry thirty five percent of a substance in any strategic message instances produced based on the strategic message model 130. If a topic XYZ was mentioned only a few times in the meeting and verified without any comments, then the topic XYZ would be weighted on the lower end of the weight scale, for example, 0.2, and a same score 0.35 based on a significance relative to other topics in the strategic message model 130, then the topic XYZ would have a weighted score of 0.7, which indicates that the topic XYZ would carry seven percent of the substance in strategic message instances generated based on the strategic message model 130. The strategic message model 130 also includes indices to data units in the base content archive 115 from which the topic had been originated such that the topic can be adjusted with the attribute values in the strategic message model 130 when the data units originating the topic in the base content archive 115 is updated.

The strategic message delivery manager 140 generates the strategic message instance 107 based on the strategic message model 130 according to particulars of a certain presentation, recorded and maintained as a delivery profile in the strategic message delivery manager 140. The strategic message delivery manager 140 sends the strategic message instance 107 to the delivery agent system 190 and monitors a presentation of the strategic message instance 107 by communicating and responding to the delivery agent program 190 regarding issues of an ongoing presentation. The strategic message delivery manager 140 communicates with the delivery agent system 190 via the communication handler 150. Detailed aspects of the delivery and interactions between the strategic message delivery manager 140 and the delivery agent system 190 are presented in FIG. 2 and corresponding description.

In this specification, the term “strategic message” indicates a message to audiences as an ordered collection of topics on a strategy that is developed and generated by the strategy management system 110 and delivered to the audiences via the delivery agent system 190. The terms “strategic topic” and “topic” are used interchangeably in this specification to indicate a topical element in the strategic message model 130 and consequently, the strategic message instance 107 formulated based on the strategic message model 130 that has been generated for a particular delivery for a certain type of audiences in a presentation, as specified in the delivery profile of the strategic message delivery manager 140. The strategic content ecosystem 100 can be utilized for any theme having characteristics similar to strategies and strategic messages, particularly in cases where the theme can be automatically generated into a content for a delivery to audiences based on live conversations and/or discussions amongst a small group of people, and the theme must be shared with the audiences via deliveries conveying the theme as accurately as possible.

FIG. 2 depicts the strategic content ecosystem 100 on components for optimally delivering the strategic messages, in accordance with one or more embodiments set forth herein.

The delivery agent system 190 includes a communication handler 210, a delivery content processor 220, a delivery content 230, a real-time adaptation engine 240, and a delivery evaluation engine 250. The delivery agent system 190, in communication with the strategic message delivery manager 140, facilitates a presenter 203 to deliver a presentation 263 of the strategic message instance 107 to an audience 205. The strategic message delivery manager 140 can create or activate the delivery agent system 190 for the presentation 263 and remove or deactivate the delivery agent system 190 after the presentation 263 is concluded.

In the context of public communication, consistently with this specification, the term “delivery” refers to an act of presenting certain messages and/or presentation material to the audience 205. The audience 205 reacts to delivery performance by the presenter 203 or the topics of the strategic message instance 107 of the presentation 263, which is collectively noted as a reaction 265, including but not limited to, nodding, laughing, raising hands, asking questions, etc. In certain embodiments of the present invention, the presentation 263 can be a training session for a plurality of presenters as the audience 205, for future presentations of the same strategic message instance 107, or to get familiarized with the delivery agent system 190 and various functionalities thereof.

The delivery agent system 190 is operatively coupled to delivery data devices 270 that capture the presentation 263 and the reaction 265. The delivery data devices 270 include, but are not limited to, one or more video cameras to capture a synchronized audio/video data of the presentation 263 and the reaction 265 and one or more microphones to capture audio data that are either embedded with the one or more video cameras or separated from the video cameras for audio reception throughout an auditorium of the presentation 263, in part similarly to the meeting data input/output devices 105.

The delivery content processor 220 of the delivery agent system 190 processes the inputs captured by the delivery data devices 270 into manageable data units according to media types of the inputs and labels the data units with corresponding metadata such as timestamps or other identifiers. The delivery content processor 220 stores processed inputs as the delivery content 230. The data units of the delivery content 230 are consistent with the data units of the base content archive 115.

The presenter 203 is equipped with private communication devices including a prompter, a mobile display screen, an earpiece/headset and/or any customary audio/video device that are wearable on the body of the presenter 203 or otherwise hidden from the view of the audience 205 to communicate with the delivery agent system 190 and the strategic message delivery manager 140.

The real time adaptation engine 240 continuously compares the presentation 263 and the reaction 265 as captured into the delivery content 230 with the strategic message instance 107 with respect to topic coverage and any interruption in the progression with the strategic message instance 107. For example, the real time adaptation engine 240 can detect any incidents with or requests by the audience 205 that can only be responded with information not presented in the strategic message instance 107 because an event immediately preceding the presentation 263 affected certain aspects of the topics in the strategic message instance 107 to the extent that the topics needs correction, or because a latest discovery in the field had not been reflected in the strategic message instance 107 as the discussion amongst the strategists 101 was held before the discovery. For another example, the real time adaptation engine 240 can detect a deviation from the strategic message instance 107 when the presenter 203 drifts into a certain topic that has not been prescribed in the strategic message instance 107.

The real time adaptation engine 240 reports a delivery issue 207 as detected to the strategic message delivery manager 140 in the strategy management system 110. The delivery issue 207 can be a certain piece of information appearing in the strategic message instance 107 that is outdated or incorrect due to recent events and/or development in the field, which are not applicable at the time of presentation 263.

The strategic message delivery manager 140 checks any information to resolve the delivery issue 207 from the delivery profile or from the strategic message model 130 on the delivery issue 207. The strategic message delivery manager 140 may present the delivery issue 207 to an administrator 201 monitoring the presentation 263 for an interactive input in cases where the delivery issue 207 should be resolved with a certain suggestions or guidance regarding the topics of the strategic message instance 107.

The strategic message delivery manager 140 returns the input from the administrator 201 on the delivery issue 207 or additional information discovered in the strategy management system 110 and/or the Internet to the delivery agent system 190 as a real time add-on 209 in response to the delivery issue 207, in a form of a document, a web page, a video clip or a portion of a movie, a piece of music, a song, a picture, etc. The real time add-on 209 corresponding to the delivery issue 207 can be a correction, a supplement, or an explanation regarding on the delivery issue 207 for the presenter 203 to provide to the audience 205, an alternative expression for the topic as associated in the strategic message model 130. The presenter 203 can subsequently resolves the delivery issue 207 in the presentation 263 by including the real time add-on 209 to the strategic message instance 107.

In cases where the delivery issue 207 requires extended assistance from the administrator 201 for the presentation 263, the communication handler 210 on the delivery agent system 190 and the communication handler 150 on the strategy management system 110 establish a bidirectional communication channel such that the administrator 201 can directly speak with the presenter 203 during the presentation 263 or at least until the delivery issue 207 is resolved. The communication handler 210 on the delivery agent system 190 and the communication handler 150 on the strategy management system 110 also operate in a coordinated manner for the exchange of the delivery issue 207 and the real time add-on 209 in response as noted above. The real time adaptation engine 240 iterates the process of reporting the delivery issue 207 and receiving the real time add-on 209 in response until the presentation 263 is concluded.

The delivery evaluation engine 250 keeps track of the progression in the delivery content 230 regarding the topics of the strategic message instance 107. The delivery evaluation engine 250 can be configured to alert the presenter 203 if the presentation 263 does not cover the topics of the strategic message instance 107 on time according to an allotted time schedule from the delivery profile. The delivery evaluation engine 250 scores the delivery content 230 based on topic coverage of the presentation 263. The delivery evaluation engine 250 can be configured to increase the score for any personalized expressions, a specific example, or unscripted behaviors invoking positive reactions from the audience 265 as reinforcing the delivery of respective topics in the strategic message instance 107. The delivery evaluation engine 250 sends the score for the presentation 263 upon conclusion. The strategic message delivery manager 140 retrieves the delivery content 230, stores in the base content archive 115, and augments the strategic message model 130 if the score for the presentation 263 is above a predefined threshold score for the delivery content 230.

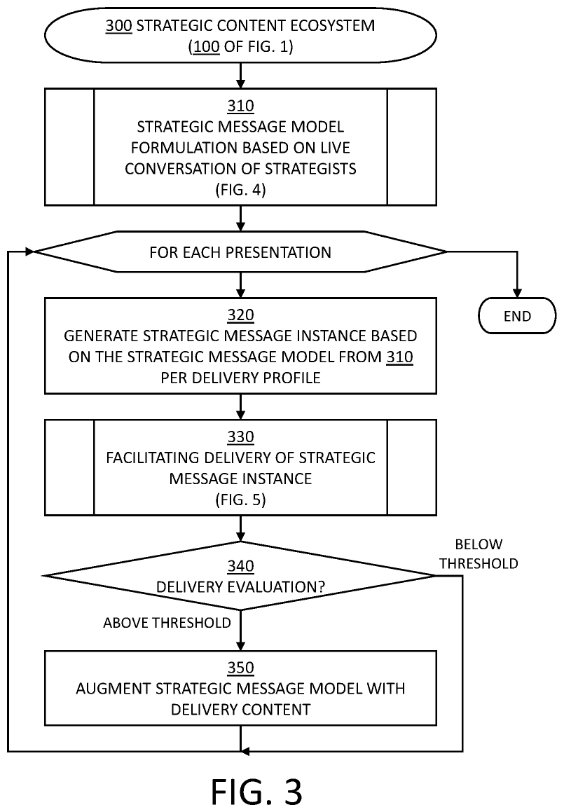

FIG. 3 depicts a workflow 300 for the strategic content ecosystem 100, in accordance with one or more embodiments set forth herein.

The strategic content ecosystem 100 generally operates in two phases including a first phase of automated formulation of the strategic message model 130 as presented in FIG. 1 and corresponding description and a second phase of handling an individual delivery based on the strategic message model 130 as presented in FIG. 2 and corresponding description. Block 310 represents the first phase of strategic message model 130 formation. Blocks 320 through 350 represent the second phase of the individual delivery.

In block 310, the strategic content ecosystem 100 captures live conversation of the strategists 101 and builds the strategic message model 130 based on the captured input. Then, the strategic content ecosystem 100 proceeds with block 320.

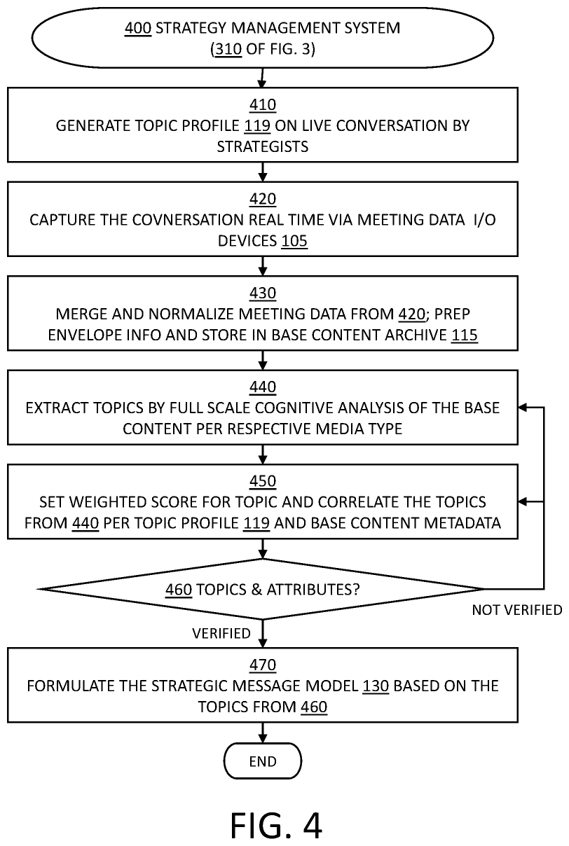

In certain embodiments of the present invention, the strategy management system 110, more specifically, the meeting data input/output devices 105, the multimedia content processor 113, and the strategic topic engine 120 generally carries out functionalities described in block 310, as assisted by the functionalities available from the CA/ML, tools 180. Outcome of block 310 is stored in the base content archive 115, the topic profile 119, and the strategic message model 130 of the strategy management system 110. Detailed steps of block 310 are presented in FIG. 4 and corresponding responses.

Blocks 320 through 350 are performed as a set for each presentation. The workflow 300 of the strategic content ecosystem 100 presented herein generates the strategic message instance 107 for each presentation per the delivery profile in block 320. It is because, even if the delivery profile is configured with the same value for all presentations, the strategic message model 130 can be updated by a previous presentation as described in block 350. The strategic message instance 107 for a specific presentation can be different from the strategic message instance 107 for a previously delivered presentation in block 320 due to the update made on the strategic message model 130 even if the delivery profile remains the same.

In block 320, the strategic content ecosystem 100 generates the strategic message instance 107 for a current presentation according to the strategic message model 130 resulting from block 310, based on parameter values set for the current presentation in the delivery profile. The delivery profile parameters can include, for example, a type of delivery as to a category selected from a training, a rehearsal, and a target audience presentation, a format of delivery as in broadcast, in-person, web cast, if the delivery is private to a selected group or open to the public, how large an expected size of the audience 205, an estimated duration of the current presentation, a geographical location of in-person presentation or a geographical distribution of the audience 205 accessing the presentation via digital communication network or any other communication channel, a target audience, the expected demography of the audience 205 in comparison to the target audience of the strategic message instance 107. According to the delivery profile indicating if the presentation is a political campaign or a promotion of a neighborhood grocery store brand, the strategic message delivery manager 140 customizes aspects of the strategic message instance 107 from a format of the current presentation to word choices amongst various alternative expressions available from the strategic message model 130. The strategic message instance 107 is a full content for a presentation, including a script for a presentation with selected expressions for topics to present, and base content stored in the base content archive 115 for related topics, and other multimedia delivery materials. Then, the strategic content ecosystem 100 proceeds with block 330.

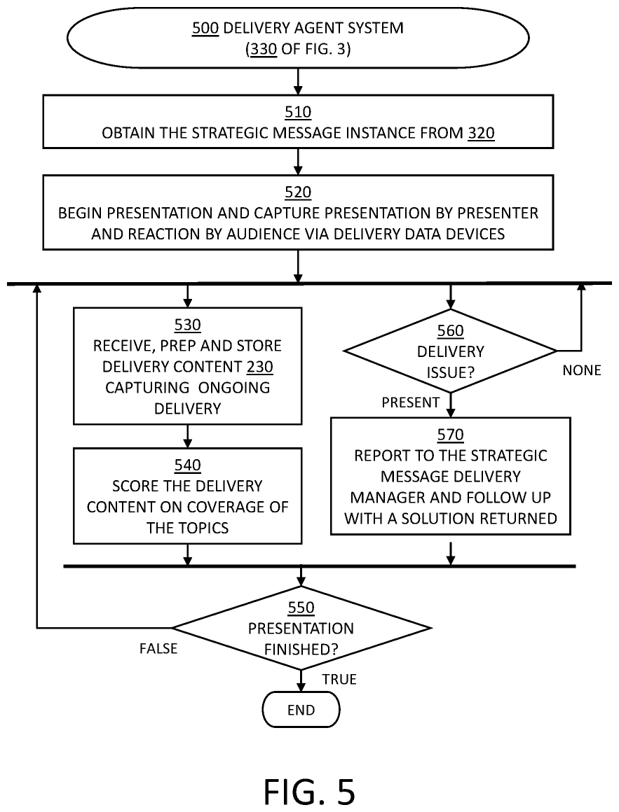

In block 330, the strategic content ecosystem 100 facilitates a delivery of the strategic message instance 107 generates from block 320. The delivery agent system 190 in concert with the strategic message delivery manager 140 handles the delivery by recording the presentation 263 into the delivery content 230, by monitoring the presentation 263 for any delivery issue 207, and by adding the real time add-on 209 to the presentation 263 in response to the delivery issue 207. During the presentation 263, the delivery agent system 190 continues evaluation according to the progression of topics covered in the presentation 263, as noted in FIG. 2 and corresponding description. Detailed steps of block 330 while the presentation 263 is ongoing are presented in FIG. 5 and corresponding description. When the presentation 263 concludes, the strategic content ecosystem 100 proceeds with block 320.

In block 340, the strategic content ecosystem 100 determines whether the presentation 263 had been concluded successfully, by comparing with the predefined threshold score for the presentation 263 with a final score for the delivery content 230. The strategic message delivery manager 140 of the strategy management system 110 would receive the delivery assessment 109, indicating the final score for the delivery content 230, from the delivery evaluation engine 250 of the delivery agent system 190. If the strategic content ecosystem 100, by the strategic message delivery manager 140, determines that the delivery content 230 is scored greater than or equal to the predefined threshold score, then, the strategic content ecosystem 100 proceeds with block 350. If the strategic content ecosystem 100, by the strategic message delivery manager 140, determines that the delivery content 230 is scored less than the predefined threshold score, then, the strategic content ecosystem 100 loops back to block 320 for a next presentation.

In block 350, the strategic content ecosystem 100 augments the strategic message model 130 with the delivery content 230, as the delivery content 230 was scored greater than or equal to the predefined threshold score, indicating that the presentation 263 thoroughly covered the topics of the strategic message instance 107 and that the presentation 263 was well received by the audience 205 specifically in spots where the reaction 265 was worth noting. The strategic content ecosystem 100, by the strategic message delivery manager 140, retrieves the delivery content 230 from the delivery agent system 190 and stores the delivery content 230 in the base content archive 115, which will initiate the strategic topic engine 120 to go over the delivery content 230 newly updated in the base content archive 115 and updates the strategic message model 130 based on the updates made in the base content archive 115 such that any subsequent presentation can take advantage of valuable contribution from the delivery content 230 of the current presentation. The strategic message model 130 is a machine learning model, and is retrained in block 350 with the updated based content archive 115 as a new training data. Then, the strategic content ecosystem 100 loops back to block 320 for a next presentation.

FIG. 4 depicts a workflow 400 for the strategy management system 110 performing block 310 of FIG. 3, in accordance with one or more embodiments set forth herein.

In block 410, the strategy management system 110 generates the topic profile 119 on live conversation by the strategists 101 to set configuration parameters for one or more topics to be discussed in a meeting, based on inputs from the strategists 101. Then, the strategy management system 110 proceeds with block 420.

As noted earlier, the topic profile 119 is a guiding rule for the strategic topic engine 120 in developing the topics from the meeting by use of cognitive analytics, in prioritizing the topics for the strategic message model 130, and in establishing the strategic message model 130 by use of machine learning for upcoming presentations. In certain embodiments of the present invention, the topic profile 119 includes configuration parameters such as: types of the meeting data input/output devices 105 available for the meeting, which will determine respective media data types that can be captured during the meeting; respective identities and roles of the strategists 101 participating in the meeting by voice recognition or facial recognition to determine how much weight would be set for a certain topic for the relative significance amongst all topics discussed in the meeting based on who suggested the topic and on how others had responded to the topic; preferences on how the topics would be verified as in choices amongst a verbal approval, saying yay or nay or any other particular code word in the meeting or otherwise type in verification codes; preferences on how the topic should be monitored upon delivery based on the significance of the topic; preferences on how the topic should be communicated to the audiences 205 in terms of tone and the manner of speech, word choices, multimedia support for the presentation of the topic; and a general characterization of the topic the strategists 101 are about to discuss in the meeting, as in if it is a whole new topic or related to any previously discussed topics, if it is a new motto for the company, a training of sales pitch for a new product.

In block 420, the strategy management system 110 captures the conversation real time by use of the meeting data input/output devices 105 while the live conversation continues. When the meeting is concluded or concurrently with capturing meeting data, the strategy management system 110 proceeds with block 430.

The strategy management system 110 processes incoming data streams of video, audio, and text by the multimedia content processor 113, either concurrently with the incoming data stream or after the meeting was concluded and the meeting data is complete. Because the components in the strategy management system 110 is functional, in certain embodiments, certain implementation of the meeting data input/output devices 105 can capture and process the meeting data with some parts of data processing functionalities described for the multimedia content processor 113. For individual device amongst the meeting data input/output devices 105 of a particular media type, certain media data processing modules may be embedded to maximize fidelity of the incoming data or any other processing capacity specific to the media type.

In block 430, the strategy management system 110, by the multimedia content processor 113, merges and normalizes the meeting data obtained from block 410 and prepares descriptive information and store as base content for further processing in the base content archive 115. Then, the strategy management system 110 proceeds with block 440.

In certain embodiments of the present invention, the multimedia content processor 113 merges and normalizes for a coordinated collection of the media data with evenly sized video display with a certain required resolution, normalized audio volumes for all speeches made by the strategists 101 regardless of their respective proximities to microphones amongst the meeting data input/output devices 105 or how loudly or quietly they spoke. As noted above, individual devices amongst the meeting data input/output devices 105 can have respective processing features and operational settings per device. Accordingly, the multimedia content processor 113 coordinates the meeting data including various media data of multimedia content to have the respective media data synchronized based on respective timestamps such that all meeting data at a certain point of time during the meeting can be analyzed together. The descriptive information for each data unit includes an identity of a speaker or author of the data unit and an input type of the data unit, selected from a preconfigured set of available input types such as {video, audio, text}. The descriptive information for the data units is also referred to as metadata, abstracts, envelope information, etc. The input type classification by the multimedia content processor 113 is made to prepare for cognitive analysis of the data unit by the strategic topic engine 120 per input type.

In block 440, the strategy management system 110, by use of the strategic topic engine 120, extracts topics by full scale cognitive analysis of the base content per respective media type, as prepared from block 430 and stored in the base content archive 115. As noted earlier, a topic indicates a topical element in the strategic message model 130 and the strategic message instance 107 produced therefrom. The topic represents a meaningful unit of idea, concept, or key point in the strategic message model 130 and the strategic message instance 107 produced therefrom. Then, the strategy management system 110 proceeds with block 420.

In certain embodiments of the present invention, the strategic topic engine 120 performs cognitive analysis per media types of video, audio, and text by use of the CA/ML tools 180. The strategic topic engine 120 performs cognitive analysis in video media data in the base content archive 115 to find information including, but not limited to, any visual expression including a gesture, facial expression, facial movement, or interactions amongst participants. The strategic topic engine 120 can identify speakers and author of other gestures and expressions by facial recognition. The strategic topic engine 120 performs cognitive analysis in audio media data in the base content archive 115 to find information including, but not limited to, speech-to-text conversion in preparation of text analysis for meanings, voice analysis for tone/pitch/volume and other manners of speech for sentiment analysis, language translation if more than one language is used for the meeting. The strategic topic engine 120 performs cognitive analysis in text data in the base content archive 115 and new text data converted from the video/audio analyses to find information including, but not limited to, topics, all meaningful expressions and phrases in relation with the topics, sentiment on the topics on the speaker and the recipients, frequencies of respective topics addressed in the meetings, etc., by use of unstructured text clustering, NLC/NLU, sentiment analysis, and any other analytical tool for text data. It should be noted that although CA/ML tools 180 are readily available, the usage of the CA/ML tools 180 in the context of the strategic content ecosystem 100 regarding the manner of use and relationship with other components in the strategic content ecosystem 100 is uniquely specified and thus, is within the scope of the present invention.

In block 450, the strategy management system 110 by the strategic topic engine 120 sets a weighted score for each of the topics extracted from block 440 and correlates the topics based on the topic profile 119 and metadata describing the base content from which each of the topic has originated. Then, the strategy management system 110 proceeds with block 460.

As noted above, the strategic topic engine 120 prepares attributes of the topics such as a weighted score of each topic indicating relative significance of the topic amongst all topics of the strategic message model 130 as being weighted by who amongst the strategists 101 authored the topic and by how well the topic has been addressed during the meeting by all strategists 101. How a new topic first introduced in the meeting is related to previously existing topics, in terms of hierarchy and priority would also be specified in a topology attribute of the topic. The attributes of the topics further include various expressions/synonyms to be used in delivery for the topic in varying audience types, annotations on the topic by a particular person or other tools for delivery specific to the topic such as anecdotes, quotes, short stories, statistics, aphorisms, demonstration, video clip, etc., to maximize delivery of the topic to the audience 205. Also, each topic would be attributed with a monitoring directive indicating how closely the topic should be monitored for any delivery issues during a presentation and what to do to resolve the delivery issues with the topic such as insufficient coverage or inconsistent comment by the presenter 203 to assure the topic to be properly communicated to the audience 205 in the presentation, as described above for the real time adaptation engine 240 in FIG. 2. Details on respective roles of the topic attributes during a presentation are presented in FIG. 5 and corresponding description.

In block 460, the strategy management system 110, by use of the strategic topic engine 120, verifies values the topics and respectively associated attributes including, but not limited to the weighted score of the topic, the topology of the topic, the expressions available for presenting the topic, and the monitoring directive for the topic, in the strategic message model 130. If the strategic topic engine 120 determines that the topics and respective attributes are set properly and ready for the strategic message model 130, then the strategic topic engine 120 proceeds with block 470. If the strategic topic engine 120 determines that any topics are not properly built, then, the strategic topic engine 120 loops back to block 440. If the strategic topic engine 120 determines that any attributes for a topic are set with an improper value, then the strategic topic engine 120 loops back to block 430.

In certain embodiments of the present invention, the strategic topic engine 120 presents the topics to the strategists 101 for verification during the meeting via a simplified interface such as a single sentence summary of the topic such as “Create Topic GHJ (Yes/No)?” on the meeting data input/output devices 105 or a connected personal device on the strategists 101. If the strategists 101 rejects the prompted topic, then the strategic topic engine 120 would exclude the topic from the strategic message model 130.

Invention is an ecosystem where content and context can be automatically derived during strategic brainstorming sessions, with classification and annotations concepts presented to the creator(s) via a simplified interface for verification and prioritization in real-time.

In certain embodiments of the present invention, the strategic topic engine 120 verifies the topics and respectively associated attributes by automatically detecting anomalies in the strategic message model 130 after adding the topics and respectively associated attributes to the strategic message model 130. The strategic message model 130 is a machine learning model that learns from the incoming topics and respectively associated attributes in combination with the currently existing topics and attributes. Any anomaly with the incoming topics and respectively associated attributes not within the bounds of the topic profile 119 and the delivery profile can be identified by producing a test message with the strategic message model 130 updated with the incoming topics and respectively associated attributes, provided that messages for presentations and/or tests previously generated by the strategic message model 130 prior to adding the incoming topics and respectively associated attributes presented had been consistent with the topic profile 119 and the delivery profile. The strategic topic engine 120 prompts the strategists 101 or other personnel to have the anomalies be either confirmed or rejected for the strategic message model 130 interactively.

In block 470, the strategy management system 110, by use of the strategic topic engine 120, formulates the strategic message model 130 based on the topics and attributes as verified from block 460. As noted, the topics can be interactively verified by the participants during the meeting. It is presumed that the meeting was concluded prior to block 470, such that all the meeting data can be reflected in the strategic message model 130. Then, the strategic topic engine 120 terminates processing and the strategy management system 110 proceeds with block 320 of FIG. 3, by handing a control over to the strategic message delivery manager 140.

After completing block 470, or block 310 of FIG. 3, the strategic message model 130 is prepared to produce the strategic message instance 107 based on newly input meeting data as processed and stored in the base content archive 115, as being guided by the topic profile 119 and the delivery profile of the strategic message delivery manager 140.

FIG. 5 depicts a workflow 500 for the delivery agent system 190 as performed in block 330 of FIG. 3, in accordance with one or more embodiments set forth herein.

In block 510, the delivery agent system 190 obtains the strategic message instance 107 produced by the strategic message delivery manager from block 320 of FIG. 3. Then, the delivery agent system 190 proceeds with block 520.

In block 520, the delivery agent system 190 begins the presentation 263 of the strategic message instance 107. The delivery agent system 190 also concurrently captures the presentation 263 by the presenter 203 and the reaction 265 by the audience 205 via the delivery data devices 270 coupled to the delivery agent system 190. Then, the delivery agent system 190 proceeds with block 530.

In block 530, the delivery agent system 190 receives incoming media stream capturing the presentation 263 and the reaction 265 from the delivery data devices 270, prepares the incoming media stream by the delivery content processor 220, and stores the processed incoming media stream capturing the delivery as the delivery content 230 in the delivery agent system 190. Then, the delivery agent system 190 proceeds with block 540.

In block 540, the delivery agent system 190, by use of the delivery evaluation engine 250, scores the delivery content 230 on coverage of the topics by the presenter 203 in the presentation 263, and the reaction 265 by the audience 205 to the presentation 263. Then, the delivery agent system 190 proceeds with block 550.

In block 550, the delivery agent system 190 determines if the presentation 263 is finished. If the delivery agent system 190 determines that the presentation 263 is finished, then, the delivery agent system 190 terminates and the strategic content ecosystem 100 proceeds with block 340 of FIG. 3. If the delivery agent system 190 determines that the presentation 263 is ongoing, then, the delivery agent system 190 loops back to block 530.

In block 560, the delivery agent system 190, by use of the real time adaptation engine 240, determines if any delivery issue is present in the ongoing presentation as being processed by blocks 530 and 540. If the real time adaptation engine 240 detects any delivery issue with the ongoing presentation in blocks 530 and 540, then the real time adaptation engine 240 proceeds with block 570. If the real time adaptation engine 240 detects no delivery issues with the ongoing presentation as being processed by blocks 530 and 540, then the real time adaptation engine 240 does not take any action.

Blocks 560 and 570 by the real time adaptation engine 240 are performed as a unit to handle the delivery issue 207. Accordingly, blocks 560 and 570 are performed concurrently with blocks 530 and 540 by the delivery data devices 270, the delivery content processor 220, and the delivery evaluation engine 250, normally processing the delivery content 230 without any delivery issue. For example, the delivery evaluation engine 250 can trigger the delivery issue 207 to the real time adaptation engine 240 for a topic coverage under a threshold value configured in the delivery profile. Similarly, if the audience 205 requested a certain information on the strategic message instance 107, as captured into the delivery content 230 as the reaction 265, but no response is available to the presenter 203 based on the content of the strategic message instance 107, the presenter 203 can trigger the delivery issue 207.

In block 570, the delivery agent system 190 reports the delivery issue 207 as detected from block 560 to the strategic message delivery manager 140 of the strategy management system 110. The strategic message delivery manager 140 responds to the delivery issue 207 by sending the real time add-on 209 corresponding to the delivery issue 207 or by opening a communication channel between the presenter 203 and the administrator 201, based on the nature of the delivery issue 207 and rules for resolution thereof as specified in the delivery profile of the strategic message delivery manager 140. The communication handler 150 of the strategy management system 110 and the communication handler 210 of the delivery agent system 190 would coordinate operations to facilitate communication between the presenter 203 and the administrator 201 via the communication channel while needed and close the communication channel when the delivery issue 207 is resolved. The delivery agent system 190 follows up with the response by the strategic message delivery manager 140 either by notifying the real time add-on 209 to the presenter 203 such that the real time add-on 209 can be utilized in the presentation 263, or by communicating instructions by the administrator 201 to the presenter how to resolve the delivery issue 207. Then, the delivery agent system 190 proceeds with block 550.

In certain embodiments of the present invention, the real time adaptation engine 240 determines a type and severity of the delivery issue 207 in block 560. In the same embodiments, the real time adaptation engine 240 reports the type and severity of the delivery issue 207 to the strategic message delivery manager 140 in block 570. The delivery profile of the strategic message delivery manager 140 has a preconfigured solutions for respective types and severity of the delivery issue 207. For Level 1 delivery issue of insufficient topic coverage, the solution is notifying the presenter 203 to correct the coverage issue by keeping up with the script as provided in the strategic message instance 107 or by summarizing the presentation with an emphasis on the topic less covered. For Level 2 delivery issue of a lack of reaction and/or signs of unsatisfactory reception by the audience 205 or certain part of the topic needs correction, the solution is providing other more effective delivery tools including alternative phrasing, short stories, examples, anecdotes, multimedia clips, etc., as the real time add-on 209 for the delivery issue 207. For Level 3 delivery issue of a general poor performance by the presenter 203, the solution is opening a communication channel directly with the administrator 201, who may be one of the strategists 101, to guide the presenter 203 through the presentation 263.

Certain embodiments of the present invention implement automated and accurate content generation based on live strategy discussion captured in multimedia data including video, audio, and text, as being cross related and synchronized for improved contextual accuracy for topic identification and classification. Certain embodiments of the present invention significantly reduce time and effort required for training presenters for efficient delivery of strategic messages base on presentation material customized for the audience level and specifics of the delivery profile and based on monitoring and issue resolution mechanism for real time deliveries. Certain embodiments of the present invention implement mechanism to assure quality of the presentation in delivering the strategic messages, by continuously evaluating topic coverage in the presentation of the strategic message and by intervening with live directives by an administrator or with a notification for the presenter to be more attentive to topic coverage. Certain embodiments of the present invention provide a mechanism to supplement the presentation on the fly with real time add-on materials if requested by the audiences to correct any error in the material or to enhance the effect of the presentation, as formulated in the strategic message models or interactively provided by the administrator of the presentation. Certain embodiments of the present invention for the strategic content ecosystem can be implemented by use of a cloud platform/data center/server farm in various types including a Software-as-a-Service (SaaS), Platform-as-a-Service (PaaS), Database-as-a-Service (DBaaS), and combinations thereof. The strategic content ecosystem can be offered for and delivered to any service providers/business entities/vendors of software applications from any location in the world in need of strategic communication framework that provides automated content generation and dynamic delivery monitoring and real time correction and evaluation of the presentation.

Embodiments of the present invention present a computer implemented method including, for instance: obtaining, by one or more processor, input data stream capturing a live discussion by one or more strategists on topics of strategic messages to deliver to an audience, the input data stream including multimedia data generated by meeting data input/output devices located at the live discussion; formulating, by the one or more processor, a strategic message model by machine learning including the topics and corresponding attributes according to a topic profile based on the input data stream as training data; generating, by the one or more processor, a strategic message instance by use of the strategic message model to deliver; monitoring, by the one or more processor, a presentation of the strategic message instance by a presenter by detecting delivery issues and responding to the presenter with respective resolutions for the delivery issues, according to a delivery profile; and updating, by the one or more processor, the strategic message model based on a delivery content capturing the presentation and a reaction by the audience corresponding to the presentation, based on ascertaining that the presentation has been evaluated as sufficiently covering the topics and well received by the audience.

Embodiments of the present invention present a computer implemented method also including, for instance: normalizing the input data stream for respective media types including video, audio, and text, merging as synchronized by respective timestamps, and storing as base content; extracting the topics and related information by performing cognitive analysis on respective media types of the base content, where video analysis derives information on speaker identities, gestures and bodily movements during the live discussion of the topics, where audio analysis derives information on a spoken language, voice analysis regarding manner of speech, and where text analysis derives information on semantics and sentiments regarding the topics; scoring each topic of the topics based on the topic profile specifying rules on how each of the speaker identities, how often the topic has been mentioned, and a consensus on the topic amongst the one or more strategists would affect a score of each topic, indicating a relative significance amongst the topics in the strategic message, where a score of a topic amongst the topics is weighted by who spoke the topic as specified in the topic profile; determining a topology of each topic of the topics correlating each topic to the rest of the topics; adding respective expressions corresponding to the topics; and adding a real time adaptation mechanism for any delivery issue of each of the topics.

Embodiments of the present invention present a computer implemented method also including, for instance: prior to the formulating, verifying the topics of the strategic messages by prompting the one or more strategists with the topics as extracted by cognitive analysis of the input data stream per media types; and excluding the topics from the strategic message model.

Embodiments of the present invention present a computer implemented method also including, for instance: detecting a delivery issue of the delivery issues during the presentation, where the delivery issue is selected from the group consisting of a coverage of a topic amongst the topics of the strategic message instance less than a preconfigured threshold value, a need for correction or more material for the presentation, and a generally poor performance in need of guidance.

Embodiments of the present invention present a computer implemented method also including, for instance: responding to the presenter with respective resolutions for the delivery issues according to the delivery profile, where the respective resolutions are selected from the group consisting of, notifying the presenter to supplement a coverage of a topic of the strategic message, sending a real time add-on to correct a topic of the strategic message or to enhance the presentation, and opening a communication channel between the presenter and an administrator of the presentation to guide through the presentation.

Embodiments of the present invention present a computer implemented method also including, for instance: concurrently with the monitoring, evaluating the presentation of the strategic message instance by the presenter based on how well the topics of the strategic message instance are covered according to time progression during the presentation and how much positive reaction had been observed by the audience.

Embodiments of the present invention present a computer implemented method also including, for instance: where the topic profile includes, for a topic, a weighted score attribute, a topology attribute, expressions attribute specifying various expressions to present the topic, and a monitoring directive attribute, indicating how closely monitor a coverage for the topic in the presentation.

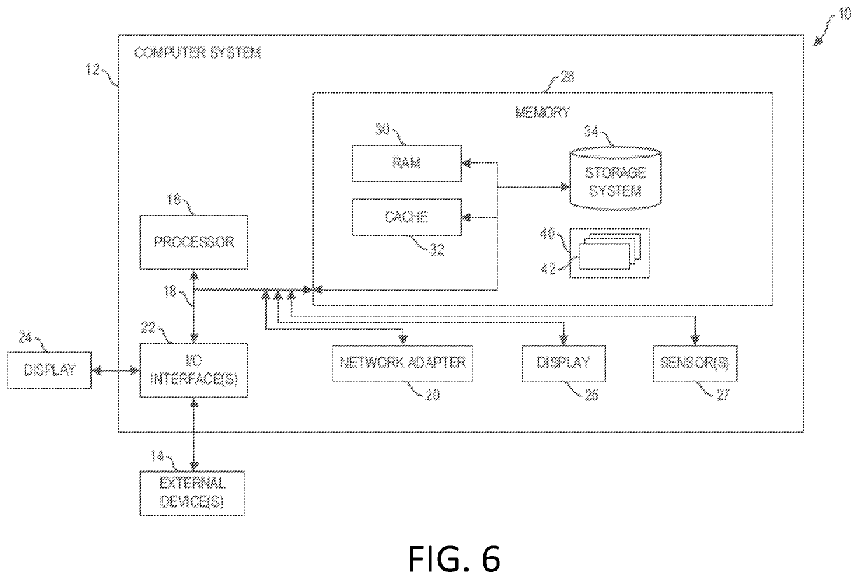

FIGS. 6-8 depict various aspects of computing, including a cloud computing system, in accordance with one or more aspects set forth herein.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 6, a schematic of an example of a computer system/cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system 12, which is operational with numerous other general purposes or special purpose computing system environments or configurations. Examples of well-known computing systems, environments, and/or configurations that may be suitable for use with computer system 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system 12 may be described in the general context of computer system-executable instructions, such as program processes, being executed by a computer system. Generally, program processes may include routines, programs, objects, components, logic, data structures, and so on that perform particular tasks or implement particular abstract data types. Computer system 12 may be practiced in distributed cloud computing environments where tasks are performed by remote processing devices that are linked through a communications network. In a distributed cloud computing environment, program processes may be located in both local and remote computer system storage media including memory storage devices.

As shown in FIG. 6, computer system 12 in cloud computing node 10 is shown in the form of a general-purpose computing device. The components of computer system 12 may include, but are not limited to, one or more processors 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 12 typically includes a variety of computer system readable media. Such media may be any available media that is accessible by computer system 12, and it includes both volatile and non-volatile media, removable and non-removable media.

System memory 28 can include computer system readable media in the form of volatile memory, such as random access memory (RAM) 30 and/or cache memory 32. Computer system 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile memory device (e.g., a “thumb drive”, “external hard drive”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program processes that are configured to carry out the functions of embodiments of the invention.

One or more program 40, having a set (at least one) of program processes 42, may be stored in memory 28 by way of example, and not limitation, as well as an operating system, one or more application programs, other program processes, and program data. Each of the operating system, one or more application programs, other program processes, and program data or some combination thereof, may include an implementation of the strategic content ecosystem 100 of FIGS. 1 and 2, including the strategic topic engine 120, the strategic message delivery manager 140, the real time adaptation engine 240, and the delivery evaluation engine 250. Program processes 42, as in the strategic topic engine 120, the strategic message delivery manager 140, the real time adaptation engine 240, and the delivery evaluation engine 250, generally carry out the functions and/or methodologies of embodiments of the invention as described herein.

Computer system 12 may also communicate with one or more external devices 14 such as a keyboard, a pointing device, a display 24, etc.; one or more devices that enable a user to interact with computer system 12; and/or any devices (e.g., network card, modem, etc.) that enable computer system 12 to communicate with one or more other computing devices. Such communication can occur via Input/Output (I/O) interfaces 22. Still yet, computer system 12 can communicate with one or more networks such as a local area network (LAN), a general wide area network (WAN), and/or a public network (e.g., the Internet) via network adapter 20. As depicted, network adapter 20 communicates with the other components of computer system 12 via bus 18.

In addition to or in place of having external devices 14 and the display 24, which can be configured to provide user interface functionality, computing node 10 in one embodiment can include another display 25 connected to bus 18. In one embodiment, the display 25 can be configured as a touch screen render and can be configured to provide user interface functionality, e.g. can facilitate virtual keyboard functionality and input of total data. Computer system 12 in one embodiment can also include one or more sensor device 27 connected to bus 18. One or more sensor device 27 can alternatively or in addition be connected through I/O interface(s) 22. The one or more sensor device 27 can include a Global Positioning Sensor (GPS) device in one embodiment and can be configured to provide a location of computing node 10. In one embodiment, the one or more sensor device 27 can alternatively or in addition include, e.g., one or more of a camera, a gyroscope, a temperature sensor, a humidity sensor, a pulse sensor, a blood pressure (BP) sensor or an audio input device.

It should be understood that although not shown, other hardware and/or software components could be used in conjunction with computer system 12. Examples, include, but are not limited to: microcode, device drivers, redundant processors, external disk drive arrays, Redundant Array of Independent/Inexpensive Disks (RAID) systems, tape drives, and data archival storage systems, etc.

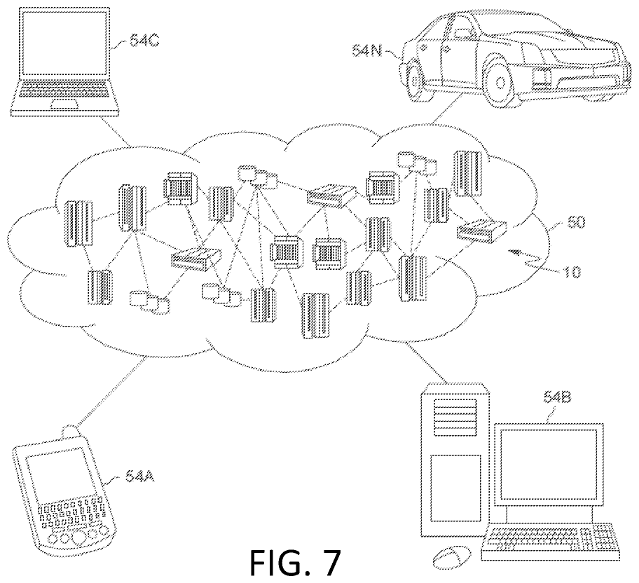

Referring now to FIG. 7, illustrative cloud computing environment 50 is depicted. As shown, cloud computing environment 50 includes one or more cloud computing nodes 10 running the strategic content system 100 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

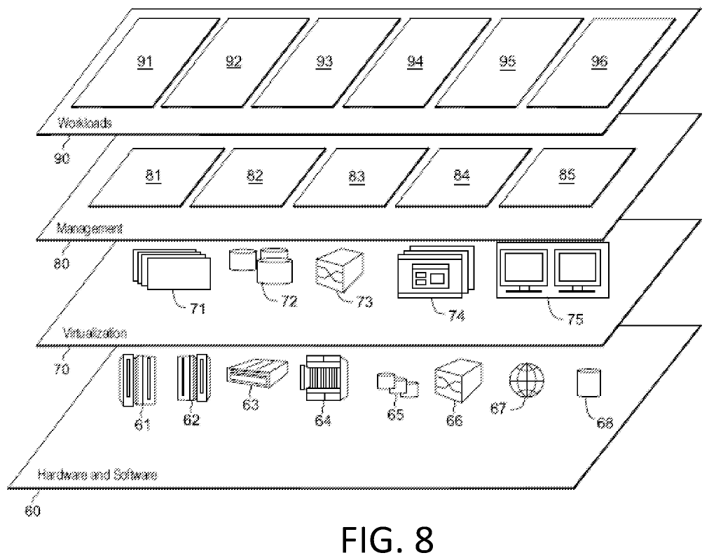

Referring now to FIG. 8, a set of functional abstraction layers provided by cloud computing environment 50 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and processing components 96 for various processes in the strategic content ecosystem, as described herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

What is claimed is:

1. A computer implemented method comprising:
obtaining, by one or more processor, input data stream capturing a live discussion by one or more strategists on topics of strategic messages to deliver to an audience, the input data stream comprising multimedia data generated by meeting data input/output devices located at the live discussion;
formulating, by the one or more processor, a strategic message model by machine learning comprising the topics and corresponding attributes according to a topic profile based on the input data stream as training data;
generating, by the one or more processor, a strategic message instance by use of the strategic message model to deliver;
monitoring, by the one or more processor, a presentation of the strategic message instance by a presenter by detecting delivery issues and responding to the presenter with respective resolutions for the delivery issues, according to a delivery profile; and
updating, by the one or more processor, the strategic message model based on a delivery content capturing the presentation and a reaction by the audience corresponding to the presentation, based on ascertaining that the presentation has been evaluated as sufficiently covering the topics and well received by the audience.

2. The computer implemented method of claim 1, the formulating comprising:
normalizing the input data stream for respective media types comprising video, audio, and text, merging as synchronized by respective timestamps, and storing as base content;
extracting the topics and related information by performing cognitive analysis on respective media types of the base content, wherein video analysis derives information on speaker identities, gestures and bodily movements during the live discussion of the topics, wherein audio analysis derives information on a spoken language, voice analysis regarding manner of speech, and wherein text analysis derives information on semantics and sentiments regarding the topics;
scoring each topic of the topics based on the topic profile specifying rules on how each of the speaker identities, how often the topic has been mentioned, and a consensus on the topic amongst the one or more strategists would affect a score of each topic, indicating a relative significance amongst the topics in the strategic message, wherein a score of a topic amongst the topics is weighted by who spoke the topic as specified in the topic profile;
determining a topology of each topic of the topics correlating each topic to the rest of the topics;
adding respective expressions corresponding to the topics; and
adding a real time adaptation mechanism for any delivery issue of each of the topics.

3. The computer implemented method of claim 1, further comprising:
prior to the formulating, verifying the topics of the strategic messages by prompting the one or more strategists with the topics as extracted by cognitive analysis of the input data stream per media types; and
excluding the topics from the strategic message model.

4. The computer implemented method of claim 1, the monitoring comprising:
detecting a delivery issue of the delivery issues during the presentation, wherein the delivery issue is selected from the group consisting of a coverage of a topic amongst the topics of the strategic message instance less than a preconfigured threshold value, a need for correction or more material for the presentation, and a generally poor performance in need of guidance.

5. The computer implemented method of claim 1, the monitoring comprising:
responding to the presenter with respective resolutions for the delivery issues according to the delivery profile, wherein the respective resolutions are selected from the group consisting of, notifying the presenter to supplement a coverage of a topic of the strategic message, sending a real time add-on to correct a topic of the strategic message or to enhance the presentation, and opening a communication channel between the presenter and an administrator of the presentation to guide through the presentation.

6. The computer implemented method of claim 1, further comprising:
concurrently with the monitoring, evaluating the presentation of the strategic message instance by the presenter based on how well the topics of the strategic message instance are covered according to time progression during the presentation and how much positive reaction had been observed by the audience.

7. The computer implemented method of claim 1, wherein the topic profile comprises, for a topic, a weighted score attribute, a topology attribute, expressions attribute specifying various expressions to present the topic, and a monitoring directive attribute, indicating how closely monitor a coverage for the topic in the presentation.

8. A computer program product comprising:
a computer readable storage medium readable by one or more processors and storing instructions for execution by the one or more processors for performing a method comprising:
obtaining input data stream capturing a live discussion by one or more strategists on topics of strategic messages to deliver to an audience, the input data stream comprising multimedia data generated by meeting data input/output devices located at the live discussion;
formulating a strategic message model by machine learning comprising the topics and corresponding attributes according to a topic profile based on the input data stream as training data;
generating a strategic message instance by use of the strategic message model to deliver;
monitoring a presentation of the strategic message instance by a presenter by detecting delivery issues and responding to the presenter with respective resolutions for the delivery issues, according to a delivery profile; and
updating the strategic message model based on a delivery content capturing the presentation and a reaction by the audience corresponding to the presentation, based on ascertaining that the presentation has been evaluated as sufficiently covering the topics and well received by the audience.

9. The computer program product of claim 8, the formulating comprising:
normalizing the input data stream for respective media types comprising video, audio, and text, merging as synchronized by respective timestamps, and storing as base content;
extracting the topics and related information by performing cognitive analysis on respective media types of the base content, wherein video analysis derives information on speaker identities, gestures and bodily movements during the live discussion of the topics, wherein audio analysis derives information on a spoken language, voice analysis regarding manner of speech, and wherein text analysis derives information on semantics and sentiments regarding the topics;
scoring each topic of the topics based on the topic profile specifying rules on how each of the speaker identities, how often the topic has been mentioned, and a consensus on the topic amongst the one or more strategists would affect a score of each topic, indicating a relative significance amongst the topics in the strategic message, wherein a score of a topic amongst the topics is weighted by who spoke the topic as specified in the topic profile;
determining a topology of each topic of the topics correlating each topic to the rest of the topics;
adding respective expressions corresponding to the topics; and
adding a real time adaptation mechanism for any delivery issue of each of the topics.

10. The computer program product of claim 8, further comprising:
prior to the formulating, verifying the topics of the strategic messages by prompting the one or more strategists with the topics as extracted by cognitive analysis of the input data stream per media types; and
excluding the topics from the strategic message model.

11. The computer program product of claim 8, the monitoring comprising:
detecting a delivery issue of the delivery issues during the presentation, wherein the delivery issue is selected from the group consisting of a coverage of a topic amongst the topics of the strategic message instance less than a preconfigured threshold value, a need for correction or more material for the presentation, and a generally poor performance in need of guidance.

12. The computer program product of claim 8, the monitoring comprising:
responding to the presenter with respective resolutions for the delivery issues according to the delivery profile, wherein the respective resolutions are selected from the group consisting of, notifying the presenter to supplement a coverage of a topic of the strategic message, sending a real time add-on to correct a topic of the strategic message or to enhance the presentation, and opening a communication channel between the presenter and an administrator of the presentation to guide through the presentation.

13. The computer program product of claim 8, further comprising:
concurrently with the monitoring, evaluating the presentation of the strategic message instance by the presenter based on how well the topics of the strategic message instance are covered according to time progression during the presentation and how much positive reaction had been observed by the audience.

14. The computer program product of claim 8, wherein the topic profile comprises, for a topic, a weighted score attribute, a topology attribute, expressions attribute specifying various expressions to present the topic, and a monitoring directive attribute, indicating how closely monitor a coverage for the topic in the presentation.

15. A system comprising:
a memory;
one or more processors in communication with the memory; and
program instructions executable by the one or more processors via the memory to perform a method comprising:
obtaining input data stream capturing a live discussion by one or more strategists on topics of strategic messages to deliver to an audience, the input data stream comprising multimedia data generated by meeting data input/output devices located at the live discussion;
formulating a strategic message model by machine learning comprising the topics and corresponding attributes according to a topic profile based on the input data stream as training data;
generating a strategic message instance by use of the strategic message model to deliver;
monitoring a presentation of the strategic message instance by a presenter by detecting delivery issues and responding to the presenter with respective resolutions for the delivery issues, according to a delivery profile; and
updating the strategic message model based on a delivery content capturing the presentation and a reaction by the audience corresponding to the presentation, based on ascertaining that the presentation has been evaluated as sufficiently covering the topics and well received by the audience.

16. The system of claim 15, the formulating comprising:
normalizing the input data stream for respective media types comprising video, audio, and text, merging as synchronized by respective timestamps, and storing as base content;
extracting the topics and related information by performing cognitive analysis on respective media types of the base content, wherein video analysis derives information on speaker identities, gestures and bodily movements during the live discussion of the topics, wherein audio analysis derives information on a spoken language, voice analysis regarding manner of speech, and wherein text analysis derives information on semantics and sentiments regarding the topics;
scoring each topic of the topics based on the topic profile specifying rules on how each of the speaker identities, how often the topic has been mentioned, and a consensus on the topic amongst the one or more strategists would affect a score of each topic, indicating a relative significance amongst the topics in the strategic message, wherein a score of a topic amongst the topics is weighted by who spoke the topic as specified in the topic profile;
determining a topology of each topic of the topics correlating each topic to the rest of the topics;
adding respective expressions corresponding to the topics; and
adding a real time adaptation mechanism for any delivery issue of each of the topics.

17. The system of claim 15, further comprising:
prior to the formulating, verifying the topics of the strategic messages by prompting the one or more strategists with the topics as extracted by cognitive analysis of the input data stream per media types; and
excluding the topics from the strategic message model.

18. The system of claim 15, the monitoring comprising:
detecting a delivery issue of the delivery issues during the presentation, wherein the delivery issue is selected from the group consisting of a coverage of a topic amongst the topics of the strategic message instance less than a preconfigured threshold value, a need for correction or more material for the presentation, and a generally poor performance in need of guidance.

19. The system of claim 15, the monitoring comprising:
responding to the presenter with respective resolutions for the delivery issues according to the delivery profile, wherein the respective resolutions are selected from the group consisting of, notifying the presenter to supplement a coverage of a topic of the strategic message, sending a real time add-on to correct a topic of the strategic message or to enhance the presentation, and opening a communication channel between the presenter and an administrator of the presentation to guide through the presentation.

20. The system of claim 15, further comprising:
concurrently with the monitoring, evaluating the presentation of the strategic message instance by the presenter based on how well the topics of the strategic message instance are covered according to time progression during the presentation and how much positive reaction had been observed by the audience.
